(19) United States
(12) Patent Application Publication
(10) Pub. No.: US 2022/0185599 A1
(43) Pub. Date: Jun. 16, 2022

(54) PICKING DEVICE

(71) Applicant: Panasonic Intellectual Property Management Co., Ltd., Osaka (JP)

(72) Inventors: NAOYA MIYAJI, Osaka (JP); SEIKOU ABE, Osaka (JP)

(21) Appl. No.: 17/515,621

(22) Filed: Nov. 1, 2021

(30) Foreign Application Priority Data
Dec. 15, 2020 (JP) 2020-207554

(51) Int. Cl. B65G 47/90; B65G 47/42

(52) U.S. Cl. CPC B65G 47/905; B65G 47/42; B65G 2203/0283; B65G 2203/0291; B65G 2203/041; B65G 2203/0233

(57) ABSTRACT

Workpiece 2 is imaged by imaging device 5 while imaging device 5 following transporter 1 is synchronized and moved with movement mechanism 8 so that a relative speed between transporter 1 and imaging device 5 is reduced, and movement object blur is reduced.

### BACKGROUND

### 1. Technical Field

The present disclosure relates to a picking device that picks and sorts a specific workpiece by a robot from a plurality of types of workpieces that are sorting objects to be transported.

### 2. Description of the Related Art

In recent years, in various industries in the world, a picking device, which picks and sorts a specific component by a robot from a plurality of types of components that are sorting objects, is often used. For example, in a field of home appliance recycling, from a disassembled product or a crushed product, which is no longer needed and is disassembled or roughly crushed to a size of a component, a specific component is recognized and picked to be sorted and recovered for recycling.

As a conventional picking device, for example, there is a device disclosed in Japanese Patent No. 5464176. FIG. 4 is a view illustrating the conventional picking device described in Japanese Patent No. 5464176.

In FIG. 4, conveyor 101 transports workpiece w placed on conveyor 101 in one direction. Workpiece w being transported is imaged by two-dimensional imaging device 103a that images transport path 111 from above, workpiece w on transport path 111 is detected based on a captured image, and a holding operation of detected workpiece w is instructed to robot 102 disposed on a downstream side of imaging device 103a, so that workpiece w can be moved from transport path 111 to a predetermined place.

On the other hand, as another picking device, for example, there is a device disclosed in Japanese Patent No. 5837065. FIG. 5 is a view of the picking device described in Japanese Patent No. 5837065.

In FIG. 5, height information is utilized to measure an outer shape, a position, and a posture of component P by imaging components P randomly stacked in bulk component box 202 as workpieces by three-dimensional vision sensor 201. From the measured information, an instruction can be given to robot 203 that grips component P and component P can be moved to a predetermined place.

### SUMMARY

According to one aspect of the present disclosure, there is provided a picking device that selectively picks up a specific workpiece from a plurality of workpieces which are disassembled products or crushed products of goods, the picking device including: a transporter that transports the workpieces in a transport direction that is one direction at a transport speed; an imaging device that is disposed above the transporter and acquires three-dimensional information of each of the plurality of workpieces by imaging each of the plurality of workpieces; an object detector that detects that the workpiece to be transported has passed through a specific position of the transporter; a movement amount detection device that measures a workpiece movement amount of the workpiece by the transporter after the object detector detects that the workpiece has passed the specific position, and issues a measurement signal indicating the measured workpiece movement amount of each of the plurality of workpieces; a movement mechanism that moves the imaging device in the transport direction in synchronization with the transport speed of the transporter based on the measurement signal from the movement amount detection device; an imaging processor that performs image processing based on the information acquired by imaging by the imaging device and generates information necessary for selectively picking up the specific workpiece from the plurality of workpieces; a robot that holds the specific workpiece from the workpieces and moves the held specific workpiece to a predetermined position based on the necessary information acquired by the imaging processor for sorting; and a controller that controls a movement of the imaging device by the movement mechanism based on the transport speed of the transporter and the measurement signal from the movement amount detection device, and controls an operation of the robot based on the transport speed of the transporter, the measurement signal from the movement amount detection device, and the necessary information for sorting acquired by the imaging processor, in which the controller controls the movement of the imaging device by the movement mechanism, and the controller causes the robot to hold the specific workpiece to move to the predetermined position to perform sorting the plurality of workpieces.

### BRIEF DESCRIPTION OF THE DRAWINGS

FIG. 1 is a schematic configuration view of a picking device according to Exemplary Embodiment 1 of the present disclosure;

FIG. 2 is a schematic view illustrating configuration elements of a part of a picking device according to Exemplary Embodiment 2 of the present disclosure as viewed from an upper portion of a transporter;

FIG. 3 is a schematic view illustrating configuration elements of a part of a picking device according to Exemplary Embodiment 3 of the present disclosure as viewed from an upper portion of a transporter;

FIG. 4 is a schematic configuration view of a conventional picking device described in Japanese Patent No. 5464176; and

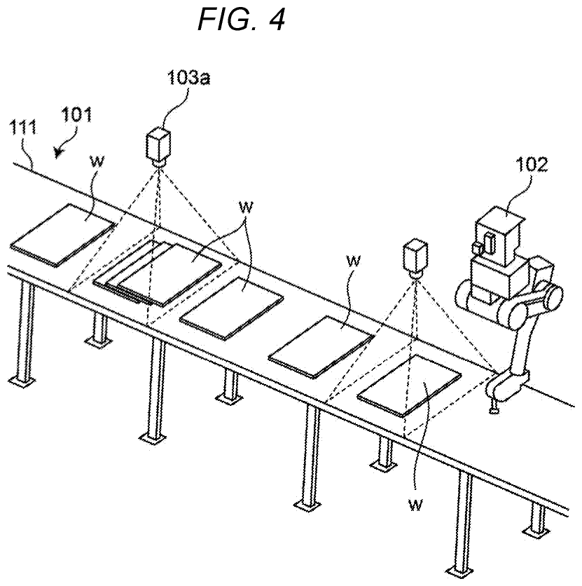

FIG. 5 is a schematic configuration view of a conventional picking device described in Japanese Patent No. 5837065.

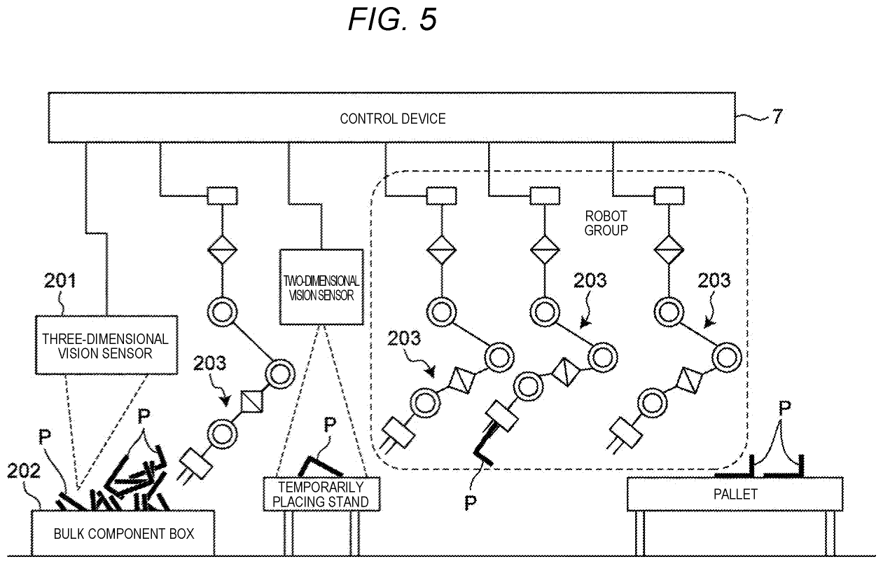

### DETAILED DESCRIPTIONS

In the configuration of Japanese Patent No. 5464176, since a two-dimensional imaging device is provided, it is not possible to obtain information on a three-dimensional outer shape, a position, and a posture.

On the other hand, in the configuration of Japanese Patent No. 5837065, three-dimensional information can be obtained, but only a stationary workpiece can be imaged.

In general, a three-dimensional imaging device takes time to capture an image, so that an accurate image cannot be acquired because a movement object blurs when the moving workpiece is imaged.

As described above, the conventional example has a problem that the three-dimensional imaging device cannot acquire the three-dimensional information such as the three-dimensional outer shape, the position, and the posture of the workpiece being transported without the movement object blur.

The present disclosure is given for solving the above-described conventional problems, and an object thereof is to provide a picking device capable of acquiring three-dimensional information of a workpiece without movement object blur by using a three-dimensional imaging device even for a moving workpiece.

Hereinafter, exemplary embodiments of the present disclosure will be described with reference to the drawings.

### Exemplary Embodiment 1

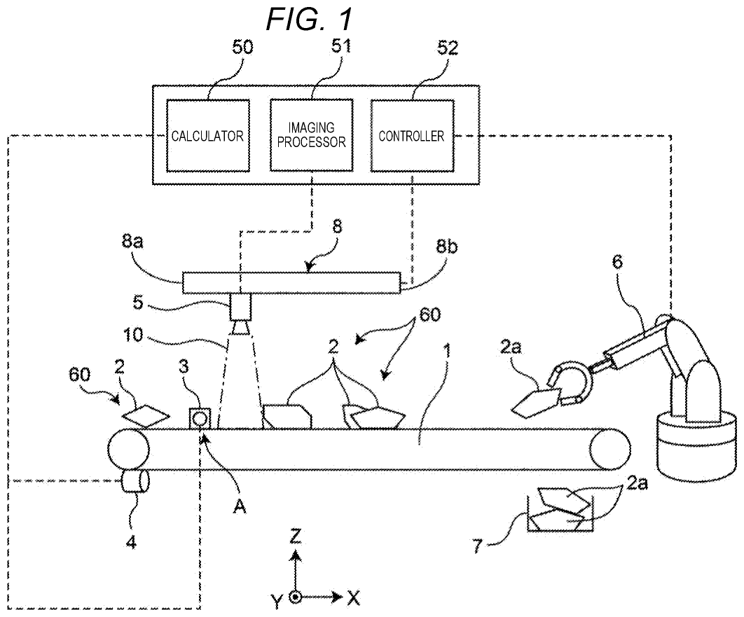

FIG. 1 is a schematic configuration view of a picking device according to Exemplary Embodiment 1 of the present disclosure.

The picking device includes transporter 1, imaging device 5, object detector 3, movement amount detection device 4, movement mechanism 8, robot 6, imaging processor 51, and controller 52, and extracts and sorts specific workpiece 2a from a plurality of workpieces 2 which are disassembled products or crushed products of goods.

In the present specification, a plurality of workpieces 2 of which position coordinates (that is, X coordinates in FIG. 1) overlap each other in a transport direction of workpiece 2 which is a disassembled product or a crushed product of goods are treated as one workpiece group 60. Conversely, a plurality of workpieces 2 of which position coordinates (that is, X coordinates in FIG. 1) do not overlap each other in the transport direction of workpiece 2 are treated as a plurality of workpiece groups 60.

Transporter 1 transports the plurality of workpieces 2 in the transport direction that is one direction, for example, at a constant transport speed. In FIG. 1, transporter 1 transports a large number of workpieces 2, which are placed on transporter 1 and include various types such as the disassembled products of goods in the transport direction (for example, to the right in FIG. 1) that is one direction at a transport speed. Here, workpiece group 60 configured of the plurality of workpieces 2 also includes workpiece group 60 in which the plurality of workpieces 2 are arranged at equal intervals, but also includes workpiece group 60 in which the plurality of workpieces 2 are not arranged at equal intervals, and the plurality of workpieces 2 are supplied to transporter 1 at random intervals and transported. As an example of transporter 1, there is a conveyor, and workpiece 2 is placed on a conveyor belt.

Imaging device 5 is disposed above transporter 1, can be reciprocated by movement mechanism 8, and images each workpiece 2 and workpiece group 60 of transporter 1 while moving in the transport direction to acquire three-dimensional information such as positions and shapes of each workpiece 2 and workpiece group 60. Imaging device 5 can move within a movement range defined by upstream limit 8a and downstream limit 8b.

Object detector 3 is configured of, for example, a photoelectric sensor and is attached to transporter 1 to detect an object, that is, each workpiece 2 that passes through specific position A on transporter 1, thereby detecting that workpiece 2 to be transported has passed specific position A of transporter 1. Since object detector 3 continuously outputs a detection signal while detecting the object, as a result, it is also possible to detect a distance between workpiece 2 and workpiece 2 in the transport direction. It is desirable that object detector 3 is installed on an upstream side with respect to an upstream end of imaging device view field 10 of imaging device 5, which is located at an upstream end of the movement range, in the transport direction.

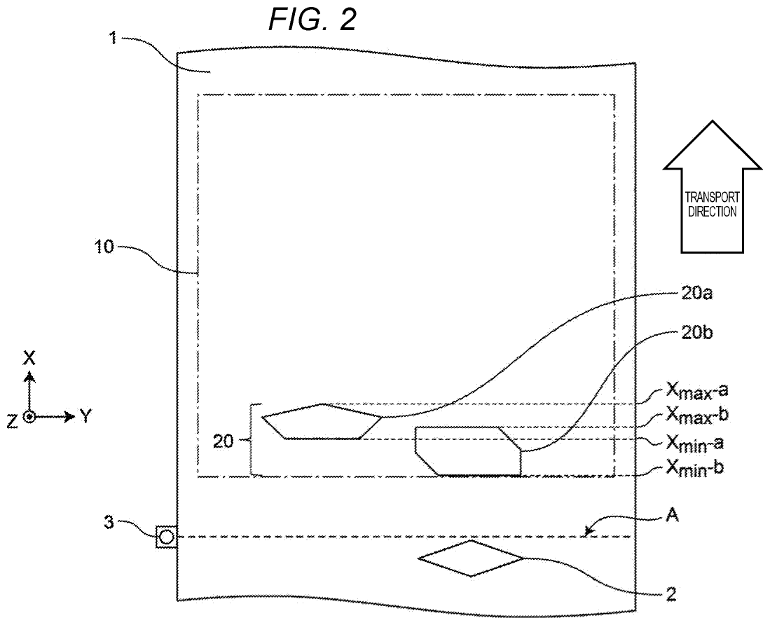

Object detector 3 detects timing when workpiece 2 to be transported has passed specific position A on transporter 1. As illustrating in FIGS. 1 and 2, an example of specific position A includes a linear shape which is along a width direction orthogonal to the transport direction of transporter 1 and is located between the upstream end of transporter 1 and the upstream end of the imaging device view field.

Movement amount detection device 4 is attached to transporter 1, and measures a workpiece movement amount of workpiece 2 by transporter 1 from specific position A after object detector 3 detects that workpiece 2 has passed specific position A to issue a measurement signal indicating the workpiece movement amount. An example of movement amount detection device 4 is an encoder attached to a motor that drives a belt in a case where transporter 1 is a belt conveyor.

Based on the measurement signal from movement amount detection device 4, movement mechanism 8 synchronizes imaging device 5 with the transport speed of workpiece 2 of transporter 1 and moves imaging device 5 in a transport direction parallel to the transport direction of transporter 1 at the same speed as the transport speed. Movement mechanism 8 is configured of, for example, a motor that is capable of driving forward/reverse rotation drive, a ball screw that is disposed in the transport direction and capable of forward/reverse rotation by the motor, and a support bracket that is screwed on the ball screw to support imaging device 5. Movement mechanism 8 advances and retreats the support bracket in the transport direction via the ball screw by the forward/reverse rotation of the motor.

Imaging processor 51 performs image processing based on the three-dimensional information acquired by imaging workpiece 2 while imaging device 5 moves in the transport direction, and acquires necessary information necessary for sorting specific workpiece 2a. That is, imaging processor 51 processes the image information of workpiece 2 imaged by imaging device 5 by image recognition, and derives the information of workpiece 2 necessary for sorting by robot 6, such as position coordinates, angles, and types.

Based on the necessary information acquired by imaging processor 51, robot 6 holds workpiece 2 to be transported, moves workpiece 2 from transporter 1 to a predetermined position outside transporter 1, and sorts workpiece 2.

Controller 52 receives the detection signal of object detector 3 and the measurement signal from movement amount detection device 4, and controls an operation of each of imaging device 5, movement mechanism 8, robot 6, and imaging processor 51 based on the input information and the transport speed of transporter 1.

A method of detecting the position of workpiece 2 on transporter 1 will be described.

Object detector 3 detects the timing when workpiece 2 has passed specific position A on transporter 1. Movement amount detection device 4 detects the movement amount of workpiece 2 by transporter 1 and outputs the measurement signal. By calculating the signal from object detector 3 and the measurement signal from movement amount detection device 4 by calculator 50, the position of workpiece 2 transported on transporter 1 in the transport direction on the downstream side of specific position A can be detected.

By grasping the position of each workpiece 2 by the above method, imaging device 5 can be controlled by controller 52 so that imaging device 5 attached to an upper portion of transporter 1 toward a transport surface of transporter 1 starts imaging at timing when workpiece 2 is placed in the view field. Here, “starts imaging at timing when workpiece 2 is placed in the view field” means when a shadow of one workpiece group 60 disappears and there is a space between workpiece group 60 and workpiece group 60, for example, when workpiece group 60 is projected in a transverse direction of the transporter while observing the upstream end of the imaging device view field.

After that, controller 52 sends the information of workpiece 2 necessary for sorting acquired from imaging processor 51 to robot 6 and also sends the measurement signal of movement amount detection device 4 to robot 6. Therefore, robot 6 picks only specific workpiece 2a of a specific type to be sorted from workpiece 2, and controller 52 controls robot 6 so as to move workpiece 2 to recovery box 7 outside transporter 1, thereby capable of sorting specific workpiece 2a.

Here, in a case where a three-dimensional imaging device capable of acquiring three-dimensional information is used as imaging device 5, it is possible to easily specify the type, the position, and specification of overlapping of workpiece 2, and to improve accuracy of sorting by robot 6.

However, in general, the three-dimensional imaging device takes time to capture an image, so when workpiece 2 being transported on transporter 1 is imaged, movement object blur occurs from a relationship between the transport speed of transporter 1 and an image capturing time of imaging device 5. Therefore, accurate information of workpiece 2 cannot be obtained and highly accurate picking cannot be performed.

Therefore, the movement object blur can be reduced by performing imaging while moving imaging device 5 in the transport direction at the same transport speed in synchronization with the movement of workpiece 2 of transporter 1. Therefore, movement mechanism 8 synchronizes imaging device 5 with the transport speed of transporter 1 to move imaging device 5 in the transport direction at the same transport speed and in parallel with the transport direction of transporter 1. Here, calculator 50 derives timing when workpiece 2 of an imaging object is transported into imaging device view field 10 of imaging device 5 from a signal from object detector 3, a measurement signal from movement amount detection device 4, and a current position of imaging device 5. Next, controller 52 issues an instruction to movement mechanism 8 so that movement mechanism 8 moves imaging device 5 in parallel while synchronizing with transporter 1, and reduces a relative speed between transporter 1, that is, workpiece 2 of the imaging object and imaging device 5.

Here, the position of imaging device 5 is detected by a position detector (for example, an encoder of a motor capable of driving forward/reverse rotation) included in movement mechanism 8 for moving imaging device 5, and the current position of imaging device 5 can be acquired.

Actually, controller 52 controls movement mechanism 8 so that movement mechanism 8 starts the movement of imaging device 5 at timing when an acceleration time is considered until imaging device 5 reaches a speed synchronized with transporter 1.

As described above, under the control of controller 52, imaging device 5 is moved in the transport direction in synchronization with transporter 1 to perform imaging by imaging device 5, so that even in three-dimensional imaging of workpiece 2 being transported using imaging device 5, it is possible to perform imaging with reduced movement object blur, and to perform sorting by highly accurate picking based on the imaging information.

However, when imaging device 5 moves in the transport direction, eventually, imaging device 5 ends up at downstream limit 8b in the transport direction, so it is necessary to perform an operation of returning of return imaging device 5 to an original position thereof. Here, the original position is, for example, upstream limit 8a in the transport direction of imaging device 5 in movement mechanism 8. The operation of returning imaging device 5 to the original position has to be performed during non-imaging of imaging device 5, that is, from the completion of imaging of certain workpiece group 60 to the start of imaging of next transported workpiece group 60. Therefore, calculator 50 derives the distance and position between workpiece groups 60 in the transport direction of workpiece group 60 based on the signal from object detector 3 and the measurement signal from movement amount detection device 4. Next, controller 52 issues an instruction to movement mechanism 8 of timing and a returning amount for returning imaging device 5 in a direction of the original position based on a derivation result of calculator 50.

In a case where each of workpiece groups 60 has the same shape and is transported on transporter 1 at equal intervals, the returning amounts by movement mechanism 8 may be the same and the timing may be a constant interval. In a case where each of workpiece groups 60 has an irregular shape or the timing of transport is random, it is necessary to control the adjustment of the returning amount and the timing.

Similarly, in a case where each of workpiece groups 60 has an irregular shape or the timing of transport is random, imaging device 5 may not return to the original position by one return operation depending on the distance between workpiece groups 60. That is, in order to image certain workpiece group 60, imaging device 5 images while being moved by movement mechanism 8, and after the imaging is completed and before starting the imaging of next workpiece group 60, it is necessary to move imaging device 5 to upstream limit 8a where movement mechanism 8 is the original position. However, in a case of a positional relationship in which before the movement of imaging device 5 to upstream limit 8a is completed, workpiece group 60 of the next imaging object passes through imaging device view field 10 of imaging device 5, it is necessary to start the next imaging before the movement to upstream limit 8a is completed. In that case, calculator 50 calculates a returning amount in time for the next imaging timing, and imaging device 5 returns to a position where the next imaging is possible based on the returning amount, and performs the next imaging.

Here, whether there is a case of a positional relationship in which workpiece group 60 of the next imaging object passes through imaging device view field 10 of imaging device 5 before the movement of imaging device 5 to upstream limit 8a is completed can be detected as follows. For example, the current position of workpiece group 60 can be detected by object detector 3 and movement amount detection device 4, and since the transport speed is known, a point, at which imaging device view field 10 of imaging device 5 attached to movement mechanism 8 trying to return to upstream limit 8a and workpiece group 60 to be transported intersect, can be acquired by calculation. When both sides reach that position, the next imaging is started.

With the above configuration, even in a case where imaging device 5 performs imaging while moving in the transport direction in synchronization with the transport operation by transporter 1, imaging device 5 does not end up at downstream limit 8b of movement mechanism 8 and can repeat the imaging. Upstream limit 8a and downstream limit 8b may be set at arbitrary positions instead of the physical end points of movement mechanism 8. However, upstream limit 8a needs to exist upstream of downstream limit 8b.

As described above, according to Exemplary Embodiment 1, imaging device 5 follows transporter 1 that transports workpiece 2 and can image workpiece 2 while moving imaging device 5 in parallel in the transport direction while synchronizing with the transport speed of transporter 1. Therefore, the three-dimensional information of workpiece 2 being transported, which could not be acquired in the past, can be acquired without movement object blur even by a three-dimensional imaging device that takes time to capture an image, and based on the acquired three-dimensional information, even workpiece 2 having a non-constant shape such as a disassembled product or a crushed product of goods can be picked with high accuracy to sort specific workpiece 2a.

### Exemplary Embodiment 2

FIG. 2 is a schematic view illustrating configuration elements of a part of a picking device according to Exemplary Embodiment 2 of the present disclosure as viewed from the upper portion of transporter 1. In FIG. 2, the same reference numerals are used for the same configuration elements as those in FIG. 1, and the description thereof will be omitted.

The reciprocating operation of imaging device 5 by movement mechanism 8 in Exemplary Embodiment 1 is a repetition of the movement of imaging device 5 during imaging in the transport direction and the movement of imaging device 5 during non-imaging in the direction opposite to the transport direction. If the non-imaging time is shorter than the time for moving imaging device 5 from the position of imaging device 5 at the end of imaging to upstream limit 8a, imaging device 5 does not return to upstream limit 8a and imaging device 5 starts to move in the transport direction for imaging next workpiece group 60. By making the reciprocating operation of imaging device 5 by movement mechanism 8 efficient, the length of movement mechanism 8 can be designed to be short.

Based on the detection signal from object detector 3 and the measurement signal from movement amount detection device 4, calculator 50 specifies the position of workpiece group 20 configured of a plurality of workpieces 2 and not spaced in the transport direction. At the timing when the position is placed in the upstream side of imaging device view field 10, the imaging accompanied by the movement of imaging device 5 by movement mechanism 8 is started, so that the time loss is reduced and the reciprocating operation of imaging device 5 by movement mechanism 8 can be performed. That is, the position of workpiece group 20 in the imaging device view field is calculated by calculator 50 from the relationship between the position of workpiece group 20 in the transport direction obtained from object detector 3 and movement amount detection device 4 and the current position of imaging device 5, and this timing is calculated by calculator 50 as timing when only workpiece group 20, in which shadows of the plurality of workpieces 2 become one when workpiece group 20 is projected in a transverse direction of the transporter from a calculation result, is placed within the imaging device view field. Controller 52 controls movement mechanism 8 so as to start the movement of imaging device 5 at the calculated timing. By doing so, the time loss is small, and the reciprocating operation of imaging device 5 by movement mechanism 8 is possible.

Here, workpiece group 20 that is not spaced in the transport direction is workpiece group 20 in which the shadows of the plurality of workpieces 2 become one when workpiece 2 is projected in the transverse direction of the transporter. That is, in each of two different workpieces 20a and 20b constituting workpiece group 20 of FIG. 2, when the transport direction is defined as X-axis, a tip of workpiece 20a on the downstream side in the transport direction is defined as Xmax−a, a rear end of workpiece 20a on the upstream side in the transport direction is defined as Xmin−a, a tip of workpiece 20b on the downstream side in the transport direction is defined as Xmax-b, and a rear end of workpiece 20b on the upstream side in the transport direction is defined as Xmin−b, workpiece group 20 is referred in which the following two relational expressions (1) and (2) are satisfied.

Xmax−a>Xmax−b>Xmin−a>Xmin−b (1)

Xmax−a>Xmax−b>Xmin−b>Xmin−a (2)

Workpiece 20a and workpiece 20b may be located opposite to each other in the transport direction.

If the above relational expressions (1) and (2) are satisfied for any two workpieces 20a and 20b, there is no upper limit to the number of workpiece groups 20 that are not spaced in the transport direction.

In a case where one workpiece 2 is being transported without forming workpiece group 20 that is not spaced in the transport direction, the imaging accompanied by the movement of imaging device 5 may be started by movement mechanism 8 at the timing when workpiece 2 is placed on the upstream side of imaging device view field 10.

As described above, the reciprocating operation of imaging device 5 by movement mechanism 8 can be made efficient, and the length of movement mechanism 8 can be designed to be short.

### Exemplary Embodiment 3

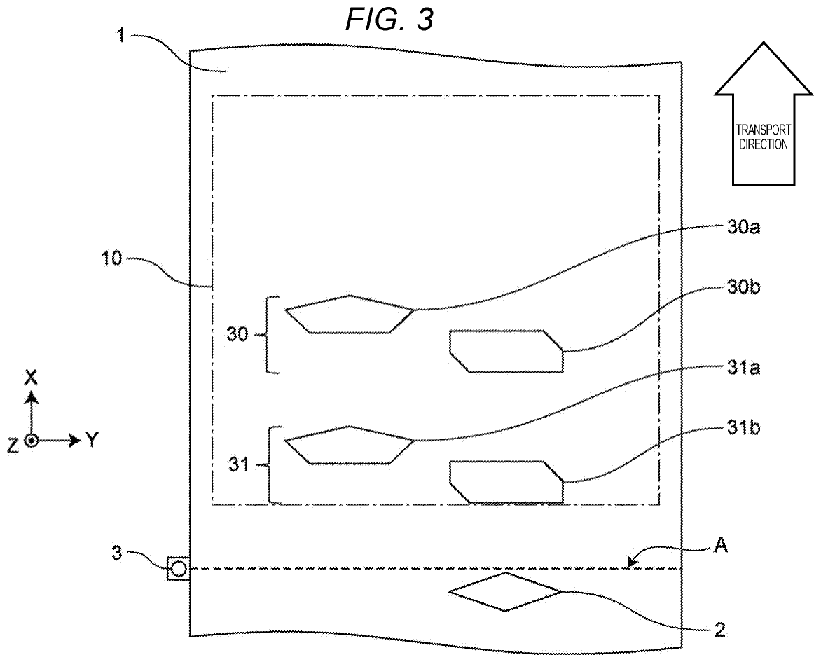

FIG. 3 is a schematic view illustrating configuration elements of a part of a picking device according to Exemplary Embodiment 3 of the present disclosure as viewed from the upper portion of transporter 1. In FIG. 3, the same reference numerals are used for the same configuration elements as those in FIGS. 1 and 2, and the description thereof will be omitted.

The reciprocating operation of movement mechanism 8 in Exemplary Embodiment 1 is a repetition of the movement during imaging in the transport direction and the movement during non-imaging in the direction opposite to the transport direction. If the non-imaging time is shorter than the time being moved from the position of imaging device 5 at the end of imaging to upstream limit 8a, imaging device 5 does not return to upstream limit 8a and starts to move from the middle of the movement in the opposite direction, that is, from the middle of returning, in the transport direction for imaging next workpiece group 60. Imaging processor 51 performs image processing on unprocessed workpiece group 60 existing in the captured image, and issues an instruction to robot 6 via controller 52.

In this way, by making the reciprocating operation of imaging device 5 by movement mechanism 8 efficient, the length of movement mechanism 8 can be designed to be short.

Based on the signal from object detector 3 and the measurement signal from movement amount detection device 4, the position of workpiece group 60 in the transport direction, the distance between workpiece groups 60 in the transport direction, and the waiting time until the imaging timing are calculated by calculator 50. At the same time, by calculating also the time required for the reciprocating operation of imaging device 5 by movement mechanism 8, it is possible to calculate time T1 to wait for the plurality of workpiece groups 60 that are not spaced in the transport direction respectively, that is, first workpiece group 30 and second workpiece group 31 in FIG. 3 are placed within imaging device view field 10, and time T2 to start the reciprocating operation and the imaging of imaging device 5 by movement mechanism 8 at the timing when first workpiece group 30 is placed within imaging device view field 10, and start the reciprocating operation and the imaging of imaging device 5 by movement mechanism 8 for imaging second workpiece group 31 after the imaging and reciprocating operations are ended. In a case where a relationship between time T1 and time T2 satisfies T1<T2, as in Exemplary Embodiment 2, the imaging is not started at the timing when first workpiece group 30 is placed upstream of imaging device view field 10 and start of the imaging is waited until the timing when second workpiece group 31 is placed upstream of imaging device view field 10, so that the reciprocating operation of imaging device 5 by movement mechanism 8 can be made efficient, and the length of movement mechanism 8 can be designed to be short. In other words, in a case where T1<T2 is satisfied, first workpiece group 30 and second workpiece group 31 are imaged at the same time. Therefore, since there is no reciprocating operation in first workpiece group 30 and second workpiece group 31, respectively, the moving distance is the smallest. Specifically, the position of workpiece group 60 within the imaging device view field is calculated from the relationship between the position of workpiece group 60 in the transport direction obtained from object detector 3 and movement amount detection device 4 and the current position of imaging device 5, and the imaging start timing when the moving distance of imaging device 5 to downstream is the smallest is calculated by calculator 50. Imaging is performed at the timing obtained by calculation.

In the example of FIG. 3, the picking device determines the reciprocating operation of imaging device 5 based on the relationship between workpiece groups T1 and T2. However, the present exemplary embodiment is not limited to this, and the reciprocating operation of imaging device 5 may be determined based on the relationship between T1 and T2 of the workpieces. For example, calculator 50 calculates the position of each of the plurality of workpieces within the imaging device view field from the relationship between the position of each of the plurality of works in the transport direction and the current position of the imaging device, and may calculate the imaging start timing when the moving distance of the imaging device to downstream is the smallest.

As described above, according to the picking device according to the exemplary embodiment of the present disclosure, the imaging device follows the transporter that transports the workpiece and can image the workpiece while moving the imaging device in parallel in the transport direction while synchronizing with the transport speed of the transporter. Therefore, the three-dimensional information of the workpiece being transported, which could not be acquired in the past, can be acquired without movement object blur even by the three-dimensional imaging device that takes time to capture the image, and based on the acquired three-dimensional information, even the workpiece having a non-constant shape such as a disassembled product or a crushed product of goods can be picked with high accuracy to sort the specific workpiece.

By appropriately combining any exemplary embodiment or modified example of the various exemplary embodiments or the modified examples, the effects of the respective exemplary embodiments or modified examples can be achieved. Further, it is possible to combine the exemplary embodiments or the examples, or the exemplary embodiments and the examples, and also to combine the features in the different exemplary embodiments or the examples.

Since the picking device according to the above aspect of the present disclosure can sort the workpiece that requires three-dimensional information by high-accurate picking, it is also possible to apply to a usage for sorting and recovering a workpiece of which a shape is not constant, such as a disassembled product or a crushed product of goods, or sorting fruits according to their shape or size.

What is claimed is:

1. A picking device that selectively picks up a specific workpiece from a plurality of workpieces which are disassembled products or crushed products of goods, the picking device comprising:
a transporter that transports the plurality of workpieces in a transport direction that is one direction at a transport speed;
an imaging device that is disposed above the transporter and acquires three-dimensional information of each of the plurality of workpieces by imaging each of the plurality of workpieces;
an object detector that detects that each of the plurality of workpieces to be transported has passed through a specific position of the transporter;
a movement amount detection device that measures a workpiece movement amount of each of the plurality of workpieces by the transporter after the object detector detects that each of the plurality of workpieces has passed the specific position, and issues a measurement signal indicating the measured workpiece movement amount of each of the plurality of workpieces;
a movement mechanism that moves the imaging device in the transport direction in synchronization with the transport speed of the transporter based on the measurement signal from the movement amount detection device;
an imaging processor that performs image processing based on the three-dimensional information acquired by the imaging device and generates necessary information necessary for selectively picking up the specific workpiece from the plurality of workpieces;
a robot that holds the specific workpiece from the plurality of workpieces and moves the held specific workpiece to a predetermined position based on the necessary information acquired by the imaging processor; and
a controller that controls a movement of the imaging device by the movement mechanism based on the transport speed of the transporter and the measurement signal from the movement amount detection device, and controls an operation of the robot based on the transport speed of the transporter, the measurement signal from the movement amount detection device, and the necessary information acquired by the imaging processor,
wherein the controller controls the movement of the imaging device by the movement mechanism, and the controller causes the robot to hold the specific workpiece to move to the predetermined position to perform sorting the plurality of workpieces.

2. The picking device of claim 1,
wherein the plurality of workpieces are transported at intervals in the transport direction,
a calculator that calculates the intervals of the plurality of workpieces based on detection information from the object detector is provided, and
the controller controls the movement mechanism so as to move the imaging device in a direction opposite to the transport direction before starting imaging based on the calculated intervals.

3. The picking device of claim 2,
wherein the calculator calculates a movement amount of the imaging device in the direction opposite to the transport direction based on the intervals of the plurality of workpieces, and
the controller controls the movement mechanism so as to move the imaging device in the direction opposite to the transport direction before starting imaging by the calculated movement amount.

4. The picking device of claim 3, further comprising:
a calculator that calculates a position of each of the plurality of workpieces within an imaging device view field from a relationship between the position of each of the plurality of workpieces in the transport direction and a current position of the imaging device obtained from the object detector and the movement amount detection device, and calculates timing when only a workpiece group, in which shadows of the plurality of workpieces become one, is placed within the imaging device view field when the plurality of workpieces are projected in a transverse direction of the transporter from the calculated position of each of the plurality of workpieces,
wherein the controller controls the movement mechanism so as to start the movement of the imaging device at the calculated timing.

5. The picking device of claim 3, further comprising:
a calculator that calculates a position of each of the plurality of workpieces within an imaging device view field from a relationship between the position of each of the plurality of workpieces in the transport direction and a current position of the imaging device obtained from the object detector and the movement amount detection device, and calculates imaging start timing which minimizes a moving distance of the imaging device to downstream,
wherein the controller controls the imaging device to perform imaging at the calculated imaging start timing.

6. The picking device of claim 1,
wherein the imaging device is configured to move within a movement range defined by an upstream limit and a downstream limit, and
the object detector is disposed on an upstream side of the transporter with respect to an upstream end of an imaging device view field of the imaging device located in the upstream limit in the transport direction.
